(19) United States
(12) Patent Application Publication
(10) Pub. No.: US 2024/0177033 A1
(43) Pub. Date: May 30, 2024

(54) Method, Device and Equipment for Selecting Key Geological Parameters of a To-Be-Prospected Block

(71) Applicants: CHINA UNIVERSITY OF GEOSCIENCES (BEIJING), Beijing (CN); BEIJING INSTITUTE OF TECHNOLOGY, Beijing (CN)

(72) Inventors: Tianshu YUAN, Beijing (CN); Jinchuan ZHANG, Beijing (CN); Bingsong YU, Beijing (CN); Lijuan JIA, Beijing (CN)

(21) Appl. No.: 18/431,472

(22) Filed: Feb. 2, 2024

Related U.S. Application Data
(63) Continuation of application No. PCT/CN2023/103971, filed on Jun. 29, 2023.

(30) Foreign Application Priority Data
Jul. 11, 2022 (CN) 202210814605.9

(51) Int. Cl. G06N 7/01

(52) U.S. Cl. CPC G06N 7/01

(57) ABSTRACT

The present disclosure provides a method for selecting key geological parameters of a to-be-prospected block. The method includes the following steps: obtaining sampling values of some known comparison blocks and a to-be-prospected block, inputting the sampling values into a mathematical model to calculate similarity probabilities of the to-be-prospected block relative to all comparison blocks, obtaining analogy probabilities of the to-be-prospected block relative to all comparison blocks based on all similarity probabilities, determining the maximum analogy probability and selecting the comparison block corresponding to the maximum analogy probability as the most relevant block of the to-be-prospected block, and selecting the target geological parameters from all geological parameters of the to-be-prospected as the key geological parameters of the to-be-prospected block, where the target geological parameters of the to-be-prospected block correspond one-to-one with and are same with the key geological parameters of the most relevant block.

### CROSS-REFERENCE TO RELATED APPLICATIONS

This application is a continuation application of International Application No. PCT/CN2023/103971, filed on Jun. 29, 2023 and entitled “method, device and equipment for selecting key geological parameters of a to-be-prospected block”, which claims priority to Chinese Patent Application No. CN 202210814605.9, filed on Jul. 11, 2022 and entitled “method, device and equipment for selecting key geological parameters of a to-be-prospected block”. The disclosures of the aforementioned applications are hereby incorporated herein by reference in their entireties.

### TECHNICAL FIELD

The present disclosure relates to unconventional oil and gas resources and, more specifically, to methods, devices and equipment for selecting key geological parameters of a to-be-prospected block.

### BACKGROUND

It is a problem that the calculation result of the quantity of unconventional oil and gas resources, such as tight and ultra-tight sandstone oil and gas, shale oil and gas, ultra heavy (viscous) oil, oil sand, coalbed methane, water-soluble gas, natural gas hydrate, of a block is not accurate, where the block may refer to a license block that is a geographically defined area for the purpose of the extraction of natural resources. Taking the shale gas as an example, it is a natural gas resource that is deposited in shale layers and can be exploited. It is difficult to accurately obtain the distribution location and reserves of shale gas in three-dimensional space, so the resource evaluation of shale gas has always been inaccurate, which brings risks to shale gas exploration.

There are many geological factors that affect the formation and enrichment of shale gas and the geological factors mainly includes stratigraphic conditions and structure characteristics, rock and mineral composition, reservoir thickness and burial depth, reservoir space type and reservoir physical properties, anisotropism of mud shale reservoirs, rock mechanical parameters, organic geochemical parameters, adsorption characteristics and gas accumulation mechanism of shale, characteristics of current regional stress field, fluid pressure and reservoir temperature, fluid saturation and fluid properties, and basic conditions of the block to be prospected (such as fracturing area and well control area).

Due to the different geological factors and conditions of different shale gas blocks, each shale gas block is particular and unique. Therefore, quantities of resource of different shale gas blocks are calculated according to different key geological parameters. If the key geological parameters selected to calculate the quantity of a block are not appropriate, calculation errors may occur, which can adversely affect the subsequent process such as the prospecting and exploring of the block. In the prior art, the selecting of key geological parameters which is performed before the calculation of quantity of resource is greatly affected by human factors, which is detrimental to the accuracy of calculation result of quantity of resource.

### SUMMARY

This and other problems are generally solved or circumvented, and technical advantages are generally achieved, by embodiments of the present disclosure which provides methods, devices and equipment for selecting key geological parameters of a to-be-prospected block.

### TECHNICAL PROBLEMS

The present disclosure provides methods, devices and equipment for selecting key geological parameters of a to-be-prospected block to solve the problem that the selecting of key geological parameters is greatly affected by human factors, and to decrease the subjectivity and increase the objectivity of the selecting of key geological parameters.

### TECHNICAL SOLUTIONS

A method for selecting key geological parameters of a to-be-prospected block is provided by the present disclosure, where the method includes the following steps:
obtaining first sampling values of key geological parameters of comparison blocks, where the comparison blocks are known blocks and the key geological parameters of each comparison block are known;
obtaining second sampling values of geological parameters of a to-be-prospected block;
inputting the first sampling values and the second sampling values into a mathematical model to calculate similarity probabilities of the to-be-prospected block relative to all the comparison blocks, respectively;
based on all the similarity probabilities, obtaining analogy probabilities of the to-be-prospected block relative to all the comparison blocks, respectively;
determining the maximum analogy probability of all the analogy probabilities and selecting the comparison block corresponding to the maximum analogy probability as the most relevant block of the to-be-prospected block; and
according to the most relevant block, selecting target geological parameters from all available geological parameters of the to-be-prospected as the key geological parameters of the to-be-prospected block, where the target geological parameters of the to-be-prospected block correspond one-to-one to and are same as the key geological parameters of the most relevant block.

Assume that the number of the comparison blocks is m. Each comparison block includes p key geological parameters. For the same comparison block, the number of first sampling values of each key geological parameter is the same; for different comparison blocks, the number of first sampling values of each key geological parameter may be different, which can be denoted by n₁, n₂, n₃, . . . nₘ. In order to calculate the similarity probabilities of the to-be-prospected block relative to all the comparison blocks, respectively, m sets of second sampling values of the to-be-prospected block which correspond one-to-one to the m comparison blocks should be prepared. Each set corresponds to a comparison block and includes p second sampling values, where the p second sampling values correspond one-to-one to p geological parameters of the to-be-prospected block, which correspond one-to-one to and are same as p key geological parameters of the corresponding comparison block.

Taking the g-th comparison block of the m comparison blocks as an example, the similarity probability of the to-be-prospected block relative to each comparison block can be calculated by the mathematical model, where the mathematical model may be:

$${F}_{g} ( Y ) = ln {q}_{g} + {Y}^{′} {S}^{- 1} {\overline{X}}_{g} - \frac{1}{2} {\overline{{X}^{′}}}_{g} {S}^{- 1} {\overline{X}}_{g} ,$$

where:
F_{g}(Y) denotes the g-th similarity probability of the to-be-prospected block relative to the g-th comparison block of the m comparison blocks;
ln q_{g} denotes natural logarithm of q_{g}, where q_{g} is the g-th prior probability of the g-th comparison block and q_{g}=n_{g}/N, where n_{g} is the number of first sampling values of each key geological parameter of the g-th comparison block, and N is the sum of all numbers of first sampling values of each key geological parameter of the m comparison blocks (that is, N=n₁+n₂+n₃+ . . . +n_{g}+ . . . ++nₘ);
Y′ denotes a matrix of a g-th set of second sampling values of the m sets of second sampling values of the to-be-prospected block, where the g-th set of second sampling values corresponds to the g-th comparison block and Y′=[y₁, y₂, y₃, . . . , yₚ], where y₁ to yₚ are p second sampling values of the g-th set of second sampling values;
S⁻¹ is an inverse matrix of S, where

$$S = {\sum }_{g = 1}^{m} {S}_{g} / ( N - m ) ,$$

S_{g} is a deviation matrix of the g-th comparison block and S_{g}=[Sₖₜ^{(g)}]_{p×p}, and where

$${S}_{k t}^{( g )} = {\sum }_{j = 1}^{{n}_{g}} ( {x}_{gjk} - {x}_{g \cdot k} ) ( {x}_{g i k} - {x}_{g \cdot k} ) ,$$

x_{gjk} is a j-th first sampling value of a k-th key geological parameter of the p key geological parameters of the g-th comparison block, x_{gik} is a i-th first sampling value of the k-th key geological parameter of the p key geological parameters of the g-th comparison block, x_{g·k} is a mean of the n_{g} first sampling values of the k-th key geological parameter of the p key geological parameters of the g-th comparison block,

$${X}_{g , k} = \frac{1}{{n}_{g}} {\sum }_{j = 1}^{{n}_{g}} {x}_{g j k} , k = 1 , 2 , … , p ,$$

both i and j are positive integer, and i≠j;

$${\overline{X}}_{g} = [ \begin{matrix}{x}_{g \cdot 1} \\ {x}_{g \cdot 2} \\ ⋮ \\ {x}_{g \cdot p}\end{matrix} ] ,$$

where x_{g·l} to x_{g·p} are respective means of first sampling values of the p key geological parameters of the g-th comparison block; and
X̅′̅_{g} is a transposed matrix of X̅_{g}.

After the key geological parameters of the to-be-prospected block are determined, the resource evaluation of the to-be-prospected block can be performed based on them. Based on the result of the resource evaluation, it can be determined that whether to prospect the to-be-prospected block.

### ADVANTAGEOUS EFFECTS OF THE DISCLOSURE

Compared with the prior art, the advantageous effects of the method for selecting key geological parameters of a to-be-prospected block provided by the present disclosure are as follows. When the selecting method is performed, the sampling values of comparison blocks and the to-be-prospected block are input into the mathematical model to calculate the similarity probabilities of the to-be-prospected block relative to all the comparison blocks, based on which the analogy probabilities can be obtained. Then, the comparison block with the maximum analogy probability can be determined as the most relevant block of the to-be-prospected block. Finally, the key geological parameters of the to-be-prospected block can be selected according to the key geological parameters of the most relevant block. Compared with the selecting method with many human factors in the prior art, the mathematical model is introduced into the selecting method in the present disclosure. The calculation process and calculation result of using the mathematical model are objective, therefore, the objectivity of the selecting of key geological parameters is increased and the subjectivity is decreased. In addition, based on the similarity probabilities and the analogy probabilities, not only the block with maximum analogy probability can be focused on, but also the blocks with analogy probabilities greater than a preset threshold can serve as references for resource evaluation of the to-be-prospected block, which can increase reference scope. The increasing of both the objectivity and the reference scope can improve the accuracy and credibility of resource evaluation of the to-be-prospected block.

### BRIEF DESCRIPTION OF THE DRAWINGS

In order to more clearly illustrate the technical solutions in the embodiments of this disclosure, the accompanying drawings to be used in the descriptions of the embodiments or the prior art will be briefly described below. Obviously, the accompanying drawings in the following description are only some embodiments of this disclosure, and for a person of ordinary skill in the art, without involving any inventive effort, other accompanying drawings may also be obtained according to these accompanying drawings.

FIG. 1 is a flow diagram of the method for selecting key geological parameters of a to-be-prospected block according to embodiments of the present disclosure;

FIG. 2 is a schematic structural diagram of the equipment for selecting key geological parameters of a to-be-prospected block according to embodiments of the present disclosure; and

FIG. 3 is a schematic structural diagram of the electronic device for selecting key geological parameters of a to-be-prospected block according to embodiments of the present disclosure.

### DETAILED DESCRIPTION OF ILLUSTRATIVE EMBODIMENTS

In the following description, for illustrative rather than limiting, specific details such as a particular system structure, technology and the like are proposed so that those skilled in the art can thoroughly understand the disclosed embodiments. However, those skilled in the art should be clear that the present disclosure may also be implemented in other embodiments without these specific details. In other cases, the detailed description of well-known systems, devices, circuits, and methods is omitted to avoid unnecessary details interfering with the description of the present disclosure.

In order to make the purpose of the present disclosure, technical solutions and advantageous effects clearer, the following will be described by specific embodiments in conjunction with the drawings.

In the present disclosure, a block to be prospected (that is, to-be-prospected block) may be a license block. It also may be a region with a certain area, such as a basin or a part of a basin. It further may be a region delimited by latitude and longitude, a work scope for mineral resources exploration or an area for mining.

As described in background, due to the different geological factors and conditions of different shale gas blocks, each shale gas block is particular and unique. Quantities of resource of different shale gas blocks are calculated according to different calculation methods which correspond to different key geological parameters. Different calculation methods and key geological parameters result in different calculation results (i.e., quantities of resource), some of which may include much error due to incorrectly selecting calculation methods and key geological parameters.

In other words, different calculation methods and key geological parameters should be selected for different blocks, because different blocks have different geological factors and conditions and each block is particular and unique. Therefore, before calculating the quantity of resources of a block, an early analysis is generally carried out to find a most appropriate calculation method and key geological parameters which can reduce errors as possible.

For the blocks with few quantitative parameters or many qualitative parameters, in the prior art, an analog method is generally used to perform the early analysis. The analog method applies the principles of analogy to compare a block to be prospected to several known blocks. The known blocks have been already prospected or explored and the quantities of the resources of the known blocks are known. Then, some blocks whose geological conditions are similar to the to-be-prospected block will be designated to be reference of calculating the quantity of resources of the to-be-prospected block. That is, the calculation methods and key geological parameters of the to-be-prospected block can be selected by making reference to the designated known blocks. However, the analog method is subjective and not objective because the designation of blocks is generally made by people which introduces much subjective factors. Besides, the number of reference targets (i.e., the designated known blocks) is generally small which limits the reference scope. Both the limited reference scope and lack of objectivity of designation of blocks can adversely affect the early analysis and further adversely affect the accuracy of the result of the subsequent resource quantity calculation.

It is a problem to be solved urgently that, when carrying out the early analysis, which geological parameters should be selected as key geological parameters from a large number of geological parameters of the block to be prospected to increase the accuracy of resource quantity calculation and the credibility of resource evaluation. To solve this problem, the present disclosure provides methods, devices and equipment for selecting key geological parameters of a to-be-prospected block. Firstly, the methods provided by the present disclosure are described as follows.

In the method embodiments below, the executor of the methods is not limited, which may be the devices for selecting key geological parameters of a to-be-prospected block provided by the present disclosure. The devices provided by the present disclosure may be an electronic device with a processor and a memory which may be mobile or non-mobile.

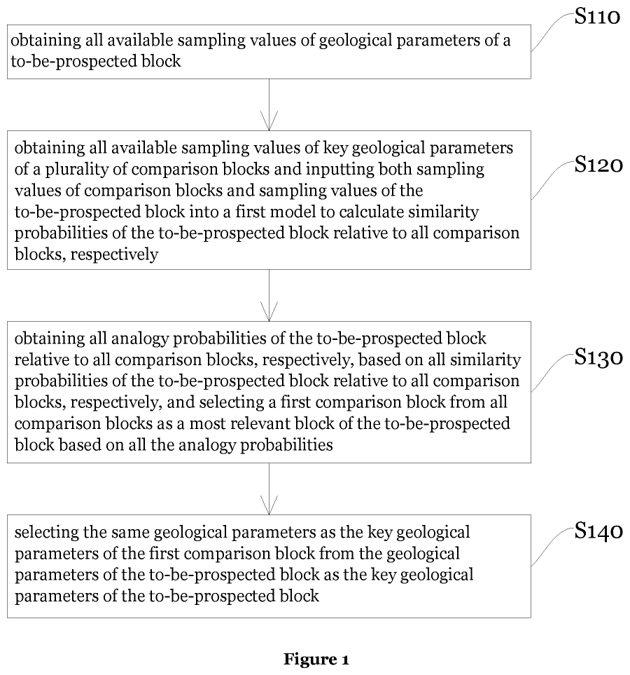

FIG. 1 is a flow chart of a method for selecting key geological parameters of a to-be-prospected block provided by an embodiment of the present disclosure. As shown in FIG. 1, the method may include steps S110 to S140 which are described respectively below.

S110: obtaining all available sampling values of geological parameters of a to-be-prospected block.

In the present disclosure, a block to be prospected (that is, to-be-prospected block) refers to a block that have already been proved that there is unconventional oil and/or gas resource deposited in the block, but the location and reserves of the resource are unknown. The unconventional oil and/or gas resource may be: shale gas, shale oil, coalbed methane, tight sandstone gas, ultra-tight sandstone gas and/or tight sandstone oil.

The geological parameters of the block to be prospected are known parameters. When performing the early analysis, various technologies will be applied to investigate as many known geological parameters of the to-be-prospected block as possible and to obtain as much geological data of the to-be-prospected block including sampling values as possible. For each geological parameter, several sampling values may be obtained. For example, Total Organic Carbon (TOC) is a geological parameter, several sampling values of TOC may be obtained by sampling and detecting. For each sampling value, it corresponds to one geological parameter. In the subsequent steps, the sampling values will be input into mathematical models to realize the selecting of the key geological parameters.

The number of the known geological parameters of a block is large, and each geological parameter, such as reservoir thickness and burial depth or rock mechanical parameters mentioned in background, may affect the location and reserves of the resource in the block to be prospected. In addition, the same geological parameter may have different affection on different blocks due to different geological conditions of the blocks. Therefore, for a block to be prospected, it is hard to determine which geological parameters should be selected to calculate the resource quantity of the block. By using the methods provided by the present disclosure, it can objectively, accurately and efficiently evaluate all geological parameters to select key geological parameters of the block to be prospected. As an early preparation for the resource calculation, this can effectively reduce the error of resource calculation and improve the credibility of resource evaluation.

S120: obtaining all available sampling values of key geological parameters of a plurality of comparison blocks and inputting both sampling values of comparison blocks and sampling values of the to-be-prospected block into a first model to calculate similarity probabilities of the to-be-prospected block relative to all comparison blocks, respectively, where for each comparison block, what are input into the first model are the sampling values of key geological parameters of the comparison block and sampling values of the geological parameters of the to-be-prospected block that correspond one-to-one to and are same as the key geological parameters of the comparison block.

Each block for comparison (that is, comparison block) is selected from known blocks which, as mentioned above, have been already prospected or explored. The key geological parameters affecting the formation and enrichment of unconventional resource of each comparison block are known. The similarity probability of each comparison block relative to the to-be-prospected block can be obtained by using the first mathematical model for calculating similarity probability to compare the sampling values of each comparison block and the sampling values of the to-be-prospected block. In the subsequent step S130, based on all similarity probabilities of all comparison blocks, it can be obtained that the comparison block in all comparison blocks which is most relevant to the to-be-prospected block. The most relevant comparison block can be as a reference block to perform the evaluation of resource quantity of the to-be-prospected block.

In step S120, the geological parameters of the to-be-prospected block which are used to compare with each comparison block are same as the key geological parameters of each comparison block. For example, TOC, vitrinite reflectance (Ro), gas content of shale and sedimentary facies are the key geological parameters of a first comparison block. When the to-be-prospected block is compared with the first comparison block, the geological parameters of the to-be-prospected block which are used to compare with the first comparison block are TOC, Ro, gas content of shale and sedimentary facies, and the sampling values of these parameters of both the to-be-prospected block and the first comparison block are input into the first model. For another example, porosity, gas saturation and permeability are the key geological parameters of a second comparison block. When the to-be-prospected block is compared with the second comparison block, the geological parameters of the to-be-prospected block which are used to compare with the second comparison block are porosity, gas saturation and permeability, and the sampling values of these parameters of both the to-be-prospected block and the second comparison block are input into the first model.

Due to the different geological factors and conditions of different blocks, for the same parameter, the sampling values of different block are different. Therefore, similarity probabilities obtained by comparing the to-be-prospected block to different comparison blocks are different, based on which the comparison blocks can be distinguished and selected. The basis for distinguishing and selecting are the calculation results of the mathematical model, which are objective rather than subjective. Therefore, compared with the subjective method in the prior art, the method provided by the present disclosure is objective which is beneficial to improve the accuracy of calculation result of resource quantity.

In an embodiment, the comparison blocks in S120 may be selected from multiple known blocks by performing steps S1201 to S1203 which are described below.

S1201: categorizing the plurality of known blocks to obtain a plurality of categorized known blocks, according to at least one geological condition.

The geological conditions of the known blocks with different categories are different. Optionally, the known blocks may be sedimentary basins that have been formed and exist on the earth, and these sedimentary basins are particular and unique due to different geological conditions, therefore they, as comparison blocks, can be classified into different categories. Optionally, a known block may be a part of a known sedimentary basin. Optionally, the geological condition may be geographical location, structural process and/or sedimentary environment. For example, according to sedimentary environment, the known blocks can be classified into marine facies blocks and continental facies blocks.

The categorizing may be performed on all available known blocks. The categorized known blocks, as comparison blocks, are similar to comparison groups in biological experiments. When the to-be-prospected block is compared with a comparison block by calculating the similarity probability using the first mathematical model, people focus on the sampling values corresponding to the key geological parameters of the comparison block rather than all geological data of all geological parameters, which can make the resource quantity evaluation targeted and efficient. The sampling values corresponding to the key geological parameters of the comparison block can be obtained from all geological data of the comparison block.

Geological parameters can be classified into qualitative parameters and quantitative parameters, according to their own properties. For example, sedimentary facies is a qualitative parameter. A sampling value of sedimentary facies may be marine facies, continental facies and transition facies of marine and continent, each of which can be represented by a digital to be computer processable. TOC is a quantitative parameter. A sampling value of TOC is a certain value in a numerical range. When selecting key geological parameters, qualitative and quantitative parameters can be considered separately to reduce the interference of irrelevant factors and make judgments more accurate. For a block with few available geological parameters or appropriate for analogical analysis, qualitative parameters can be used for analysis. On the contrary, for a block with many available geological parameters, quantitative parameters can be used for analysis. Regardless of whether qualitative or quantitative parameters are used, the selecting methods provided by the present disclosure can efficiently select key geological parameters from available geological parameters.

S1202: determining a first category of the to-be-prospected block according to the at least one geological condition.

S1203: selecting blocks with same category as the first category of the to-be-prospected block from the plurality of categorized known blocks as the comparison blocks.

It should be noted that, in the present disclosure, each sampling value is valid sampling data which is obtained from all collected sampling data excluding outliers and erroneous values. For example, the sampling value may be valid sampling data of maturity.

In the present step, it is determined that whether the category of the to-be-prospected block is same as or similar with the category of each categorized known block obtained in step S1201. If the category of a categorized known block is same as or similar with the category of the to-be-prospected block, the categorized known block will be focused as comparison block; and if not, the categorized known block may be excluded and not be considered, which can reduce the interference of irrelevant factors.

Optionally, the category of a block may be determined by its corresponding basin. If the block is a basin, the category of the block may be the category of the basin; and if the block is a part of the basin, the category of the block may be the category of the basin in which the block is located in. Although there are no two basins on earth that are exactly the same, two basins with same category have similar geological conditions and similar formation and distribution of oil and gas resources. When the category of the to-be-prospected block (or the basin in which the to-be-prospected block is located in) is determined, geological basic constraints of sedimentary structures corresponding to the category can be determined, according to which next work can be carried out. Then, based on the principle of giving priority to main category in geologic analogy and the characteristic that the information in a small scope includes the information in a big scope (for example, the information of a stratum or a sampling data of a basin includes the family information of the basin), the interested geological parameters of the known comparison blocks can be selected and the sampling values of them can be applied to the method provided by the present disclosure to select key geological parameters of the block to be prospected.

In an embodiment, the first model may be:

$${F}_{g} ( Y ) = ln {q}_{g} + {Y}^{′} {S}^{- 1} {\overline{X}}_{g} - \frac{1}{2} {\overline{{X}^{′}}}_{g} {S}^{- 1} {\overline{X}}_{g} .$$

For any one of all comparison blocks, the similarity probability of the to-be-prospected block relative to the comparison block can be calculated by inputting the sampling values of key geological parameters of the comparison block and the sampling values of the geological parameters of the to-be-prospected block that correspond one-to-one to and are same as the key geological parameters of the comparison block.

Assume that the number of the comparison blocks is m. In order to use the first model provided in the present embodiment to calculate similarity probability, p key geological parameters of each comparison block should be taken. The number of sampling values of each key geological parameter of each comparison block may be different, which can be denoted by n₁, n₂, n₃, . . . nₘ. The number of sampling values of each key geological parameter of the same comparison block is the same. What should be taken from all available sampling values of the to-be-prospected block are m sampling value sets. The m sampling value sets corresponds one-to-one to the m comparison blocks. Each sampling value set includes p sampling values of the to-be-prospected block. The p sampling values correspond one-to-one to p geological parameters of the to-be-prospected block which corresponds one-to-one to and are same as the p key geological parameters of a corresponding comparison block.

In the first model provided in the present embodiment:
F_{g}(Y) denotes the g-th similarity probability of the to-be-prospected block relative to the g-th comparison block of the m comparison blocks, where g is positive integer ranging from 1 to m;
ln q_{g} denotes natural logarithm of q_{g}, where q_{g} is the g-th prior probability of the g-th comparison block and q_{g}=n_{g}/N, where n_{g} is the number of sampling values of each key geological parameter of the g-th comparison block, and N is the sum of all numbers of sampling values of each key geological parameters of the m comparison blocks (that is, N=n₁+n₂+n₃+ . . . +n_{g}+ . . . +nₘ);
Y′ denotes a matrix of the g-th sampling value set of the m sampling value sets of the to-be-prospected block, where the g-th sampling value set corresponds to the g-th comparison block and Y′=[y₁, y₂, y₃, . . . , yₚ], and where y₁ to yₚ are p sampling values of the g-th sampling value set, y₁ is the sampling value of a first geological parameter of the to-be-prospected block which corresponds to and is same as a first key geological parameter of the p key geological parameters of the g-th comparison block, y₂ is the sampling value of a second geological parameter of the to-be-prospected block which corresponds to and is same as a second key geological parameter of the p key geological parameters of the g-th comparison block, y₃ is the sampling value of a third geological parameter of the to-be-prospected block which corresponds to and is same as a third key geological parameter of the p key geological parameters of the g-th comparison block, and so on; actually, Y′ is a transposed matrix of Y which is a matrix of y₁ to yₚ;
S⁻¹ is an inverse matrix of S, where

$$S = {\sum }_{g = 1}^{m} {S}_{g} / ( N - m ) ,$$

S_{g} is a deviation matrix of the g-th comparison block and S_{g}=[Sₖₜ^{(g)}]_{p×p}, and where

$${S}_{k t}^{( g )} = {\sum }_{j = 1}^{{n}_{g}} ( {x}_{g j k} - {x}_{g \cdot k} ) ( {x}_{g i k} - {x}_{g \cdot k} ) ,$$

x_{gjk} is a j-th sampling value of a k-th key geological parameter of the p key geological parameters of the g-th comparison block, x_{gik} is a i-th first sampling value of the k-th key geological parameter of the p key geological parameters of the g-th comparison block, x_{g·k} is a mean of the n_{g} sampling values of the k-th key geological parameter of the p key geological parameters of the g-th comparison block,

$${X}_{g , k} = \frac{1}{{n}_{g}} {\sum }_{j = 1}^{{n}_{g}} {x}_{g j k} , k = 1 , 2 , … , p ,$$

both i and j are positive integer, and i≠j;

$${\overline{X}}_{g} = [ \begin{matrix}{x}_{g \cdot 1} \\ {x}_{g \cdot 2} \\ ⋮ \\ {x}_{g \cdot p}\end{matrix} ] ,$$

where x_{g·l} to x_{g·p} are respective means of sampling values of the p key geological parameters of the g-th comparison block; and
X̅′̅_{g} is a transposed matrix of X̅_{g}.

S130: obtaining all analogy probabilities of the to-be-prospected block relative to all comparison blocks, respectively, based on all similarity probabilities of the to-be-prospected block relative to all comparison blocks, respectively, and selecting a first comparison block from all comparison blocks as a most relevant block of the to-be-prospected block based on all the analogy probabilities, where the analogy probabilities correspond one-to-one to the similarity probabilities.

As mentioned above, due to different geological factors and conditions of different blocks, similarity probabilities of the to-be-prospected block relative to different comparison blocks are different. Similarly, analogy probabilities of the to-be-prospected block relative to different comparison blocks are different, too.

In an embodiment, S130 may be performed by the following steps:
inputting all similarity probabilities of the to-be-prospected block relative to all comparison blocks, respectively, to a second model to calculate all analogy probabilities of the to-be-prospected block relative to all comparison blocks, respectively;
determining a maximum analogy probability of all analogy probabilities of the to-be-prospected block relative to all comparison blocks; and
selecting the first comparison block from all comparison blocks, where the first comparison block corresponds to the maximum analogy probability of all analogy probabilities.

In the present embodiment, the analogy probabilities are obtained by inputting the similarity probabilities into the second model, and the most relevant block with the maximum analogy probability is determined.

Discriminant analysis can be performed for predictive processing. Discriminant analysis refers to stablishing discriminant model according to certain criteria based on the observation data of a batch of known samples of various of known categorized research objects (e.g., sampling values of comparison blocks), and then discriminating and classifying the samples of unknown objects (e.g., sampling values of the to-be-prospected block).

In an embodiment, the discriminant analysis may be performed based on Bayes Theorem. For a to-be-prospected block Y and m comparison blocks, according to Bayes Theorem, the analogy probability of the block Y relative to the g-th comparison block of the m comparison blocks may be conditional probability of g given Y, which can be denoted by p{g/Y}. When all analogy probabilities p{1/Y}, p{2/Y}, p{3/Y}, . . . , p{g/Y}, . . . , p{m/Y} are obtained, the maximum analogy probability and the comparison block corresponding to the maximum analogy probability can be determined, which can be the most relevant block of the to-be-prospected block.

Based on Bayes Theorem and Law of Total Probability, the second model may be:

$$p \{ g / Y \} = \frac{{q}_{g} \cdot {F}_{g} ( Y )}{{\sum }_{j = 1}^{m} {q}_{j} \cdot {F}_{j} ( Y )} ,$$

where:
m is the number of comparison blocks;
p{g/Y} denotes a g-th analogy probability of the to-be-prospected block relative to the g-th comparison block of the m comparison blocks, where g ranges from 1 to m;
q_{g} is the g-th prior probability of the g-th comparison block and q_{g}=n_{g}/N, where n_{g} is the number of sampling values of each key geological parameter of the g-th comparison block of the m comparison blocks, and N is the sum of all numbers of sampling values of each key geological parameters of each comparison block of the m comparison blocks (that is, N=n₁+n₂+n₃+ . . . +n_{g}+ . . . ++nₘ);
similarly, qⱼ is the j-th prior probability of the j-th comparison block and qⱼ=nⱼ/N, where nⱼ is the number of sampling values of each key geological parameter of the j-th comparison block of the m comparison blocks, and N is the sum of all the numbers;
F_{g}(Y) denotes the g-th similarity probability of the to-be-prospected block relative to the g-th comparison block, which may be calculated by the first model; and
similarly, Fⱼ(Y) denotes the j-th similarity probability of the to-be-prospected block relative to the j-th comparison block, which may be calculated by the first model.

In the present embodiment, the selecting method provided by the present disclosure is realized mainly by the first model and the second model. The first model and the second model are mathematical. Therefore, the calculation process and calculation result are objective, which effectively improves the objectivity of the method of selecting of key geological parameters. In addition, the calculation process of the models can be realized by computer. Compared with manually realization of the selecting process in the prior art, computer realization is more efficient.

Generally, for the same comparison block, the analogy probability is positively correlated with the similarity probability. That means, a comparison block with the maximum similarity probability is generally the block with the maximum analogy probability. In this situation, the most relevant block of the to-be-prospected block can be determined by finding out the maximum similarity probability, and the analogy probability may serve as a value for determining whether the most relevant block can serve as a comparison block. If the analogy probability of the most relevant block is less than a preset threshold which may be 0.8 or 0.9, the block may not be selected as a comparison block even though its analogy probability is maximum. In other words, the analogy probability may serve as an indicator to assess whether a comparison block is relevant enough to the to-be-prospected block.

A comparison block with analogy probability greater than the preset threshold, even though not the most relevant block, it may provide similar sampling values with sampling values of the to-be-prospected block. And, conditions and experience of this comparison block corresponding to the similar sampling values can be used on the to-be-prospected block. That means, in the present embodiment, not only the most relevant block can serve as reference for performing evaluation of resource quantity of the to-be-prospected block, but also the comparison blocks with analogy probability greater than the preset threshold can serve as references, which can increase reference scope and result in improvement of the accuracy and credibility of evaluation of the resource quantity.

S140: selecting the same geological parameters as the key geological parameters of the first comparison block from the geological parameters of the to-be-prospected block as the key geological parameters of the to-be-prospected block.

After the key geological parameters of the to-be-prospected block are determined, the resource evaluation of the to-be-prospected block can be performed based on the key geological parameters. The key geological parameters can be prioritized when the resource evaluating of the to-be-prospected block is performed, which can effectively improve the efficiency of calculation and prediction of resource quantity. Based on the resource evaluating, people's understanding of the to-be-prospected block can be improved, which is of great significance to subsequent prospecting of the block to be prospected.

The resource evaluation may include evaluating the quantity of resource of the to-be-prospected block. The evaluating of the quantity of resource may be performed by calculating method or modeling method. For example, the evaluating may be performed by the method of Basin Modeling which enables people to investigate the dynamics of sedimentary basins and their associated fluids to determine if the past conditions were appropriate to fill potential reservoirs with hydrocarbon and preserve the potential reservoirs. Basin Modeling is generally performed by known basin modeling software. When Basin Modeling is performed, multiple parameters including the determined key geological parameters will be input into computer. Then the basin modeling software runs to obtain a modeling result including the location and reserves of the resource in the prospected block. After the resource evaluation is completed, it can be determined whether to prospect the to-be-prospected block according to the result of the resource evaluation. For example, if the evaluation result indicates that the resource reserve is large, it can be determined that the to-be-prospected block may be prospected. Conversely, if the evaluation result indicates that the resource reserve is small, it may be determined that the to-be-prospected block will not be prospected to avoid losses.

The first comparison block mentioned in S140 is the most relevant block of the to-be-prospected determined in S130. In addition to selecting key parameters of the to-be-prospected block according to the first comparison block, it can be as reference that the analysis method and calculating method of resource quantity of the first comparison block and field experience of the first comparison block such as sampling and adsorption.

Compared with the prior art, the advantageous effects of the method including steps S110 to S140 are as follows. When the method is performed, the sampling values of comparison blocks and the to-be-prospected block are input into the first mathematical model to calculate the similarity probabilities of the to-be-prospected block relative to all the comparison blocks, based on which the analogy probabilities can be obtained. Then, the comparison block with the maximum analogy probability can be determined as the most relevant block of the to-be-prospected block. Finally, the key geological parameters of the to-be-prospected block can be selected according to the key geological parameters of the most relevant block. Compared with the selecting method with many human factors in the prior art, the first mathematical model is introduced into the selecting method in the present disclosure. The calculation process and calculation result of using the first mathematical model are objective, therefore, the objectivity of the selecting of key geological parameters is increased and the subjectivity is decreased. In addition, based on the similarity probabilities and the analogy probabilities, not only the block with maximum analogy probability can be focused on, but also the blocks with analogy probabilities greater than a preset threshold can serve as references for resource evaluation of the to-be-prospected block, which can increase reference scope. The increasing of both the objectivity and the reference scope can improve the accuracy and credibility of evaluation of the resource quantity of the to-be-prospected block.

It should be understood that the size of the serial numbers of the steps appearing in the above embodiments do not imply the execution order. The execution order of each step shall be determined by its function and internal logic, and its serial number shall not constitute any qualification for the embodiment of the present disclosure.

Corresponding to methods for selecting key geological parameters of a to-be-prospected block disclosed by the above embodiments, the present disclosure provides equipment for selecting key geological parameters of a to-be-prospected block which described as follows.

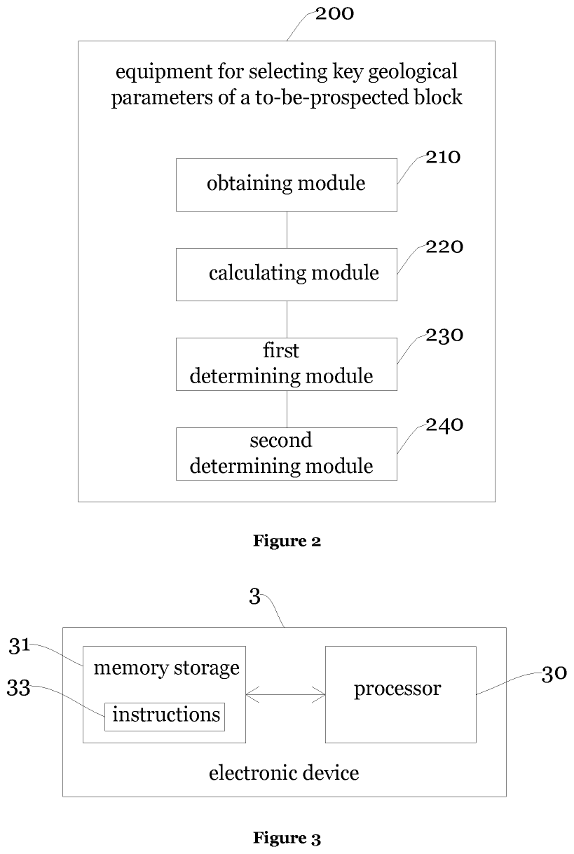

In an embodiment, as shown in FIG. 2, the equipment 200 provided by the present disclosure may include an obtaining module 210, a calculating module 220, a first determining module 230 and a second determining module 240, which are described below.

The obtaining module 210 is configured to obtain available sampling values of geological parameters of a to-be-prospected block and key geological parameters of a plurality of comparison blocks, where the to-be-prospected block is with unconventional oil and gas resource.

The calculating module 220 is configured to calculate similarity probabilities of the to-be-prospected block relative to all comparison blocks, respectively, by inputting both sampling values of comparison blocks and sampling values of the to-be-prospected block into a first model, where for each comparison block, what are input into the first model are the sampling values of key geological parameters of the comparison block and sampling values of the geological parameters of the to-be-prospected block that correspond one-to-one to and are same as the key geological parameters of the comparison block.

The first determining module 230 is configured to select a first comparison block from all comparison blocks as a most relevant block of the to-be-prospected block based on analogy probabilities of the to-be-prospected block relative to all comparison blocks, respectively, which are obtained based on all the similarity probabilities, where the analogy probabilities correspond one-to-one to the similarity probabilities.

The second determining module 240 is configured to determine the same geological parameters as the key geological parameters of the first comparison block of the geological parameters of the to-be-prospected block as the key geological parameters of the to-be-prospected block.

In an embodiment, the calculating module 220 is further configured to:
categorize, according to at least one geological condition, the plurality of known blocks to obtain a plurality of categorized known blocks;
determine a category of the to-be-prospected block according to the at least one geological condition; and
select, from the plurality of categorized known blocks, the m comparison blocks having a same category as the category of the to-be-prospected block.

In an embodiment, the first model used by the calculating module 220 may be:

$${F}_{g} ( Y ) = ln {q}_{g} + {Y}^{′} {S}^{- 1} {\overline{X}}_{g} - \frac{1}{2} {\overline{{X}^{′}}}_{g} {S}^{- 1} {\overline{X}}_{g} ,$$

where:
F_{g}(Y) denotes a g-th similarity probability of the to-be-prospected block relative to a g-th comparison block of m comparison blocks;
ln q_{g} denotes natural logarithm of q_{g}, q_{g} is a g-th prior probability of the g-th comparison block and q_{g}=n_{g}/N, n_{g}/N is a number of sampling values of each key geological parameter of the g-th comparison block of the m comparison blocks, N=n₁+n₂+n₃+ . . . +n_{g}+ . . . ++nₘ, and n₁ to nₘ are respective numbers of sampling values of each key geological parameter of m comparison blocks;
Y′ denotes a matrix of a g-th set of sampling values of m sets of sampling values of the to-be-prospected block, the g-th set of sampling values corresponds to the g-th comparison block, Y′=[y₁, y₂, y₃, . . . , yₚ], and y₁ to yₚ are p sampling values of the g-th set of second sampling values;
S⁻¹ is an inverse matrix of S,

$$S = {\sum }_{g = 1}^{m} {S}_{g} / ( N - m ) ,$$

S_{g} is a deviation matrix of the g-th comparison block and S_{g}=[Sₖₜ^{(g)}]_{p×p}, where

$${S}_{k t}^{( g )} = {\sum }_{j = 1}^{{n}_{g}} ( {x}_{gjk} - {x}_{g \cdot k} ) ( {x}_{g i k} - {x}_{g \cdot k} ) ,$$

x_{gjk} is a j-th sampling value of a k-th key geological parameter of the p key geological parameters of the g-th comparison block, x_{gik} is a i-th first sampling value of the k-th key geological parameter of the p key geological parameters of the g-th comparison block, x_{g·k} is a mean of the n_{g} sampling values of the k-th key geological parameter of the p key geological parameters of the g-th comparison block,

$${X}_{g , k} = \frac{1}{{n}_{g}} {\sum }_{j = 1}^{{n}_{g}} {x}_{g j k} , k = 1 , 2 , … , p ,$$

both i and j are positive integer, and i≠j;

$${\overline{X}}_{g} = [ \begin{matrix}{x}_{g \cdot 1} \\ {x}_{g \cdot 2} \\ ⋮ \\ {x}_{g \cdot p}\end{matrix} ] ,$$

where x_{g·l} to x_{g·p} are respective means of the n_{g} sampling values of the p key geological parameters of the g-th comparison block; and
X̅′̅_{g} is a transposed matrix of X̅_{g}.

In an embodiment, the first determining module 230 is further configured to:
calculate the m analogy probabilities of the to-be-prospected block relative to the m comparison blocks by inputting the m similarity probabilities of the to-be-prospected block relative to the m comparison blocks to a second model;
determine a maximum analogy probability of the m analogy probabilities of the to-be-prospected block relative to the m comparison blocks; and
select the first comparison block from the m comparison blocks, with the first comparison block corresponding to the maximum analogy probability of the m analogy probabilities.

In an embodiment, the second model may be constructed based on Bayes Theorem.

In an embodiment, the second model may be:

$$p \{ g / Y \} = \frac{{q}_{g} \cdot {F}_{g} ( Y )}{{\sum }_{j = 1}^{m} {q}_{j} \cdot {F}_{j} ( Y )} ,$$

where:
m is the number of comparison blocks;
p{g/Y} denotes a g-th analogy probability of the to-be-prospected block relative to the g-th comparison block of the m comparison blocks, where g ranges from 1 to m;
q_{g} is the g-th prior probability of the g-th comparison block and q_{g}=n_{g}/N, where n_{g} is the number of sampling values of each key geological parameter of the g-th comparison block of the m comparison blocks, and N=n₁+n₂+n₃+ . . . +n_{g}+ . . . ++nₘ;
qⱼ is the j-th prior probability of the j-th comparison block and qⱼ=nⱼ/N, where nⱼ is the number of sampling values of each key geological parameter of the j-th comparison block of the m comparison blocks, and N is the sum of all the numbers;
F_{g}(Y) denotes the g-th similarity probability of the to-be-prospected block relative to the g-th comparison block, which may be calculated by the first model; and
Fⱼ(Y) denotes the j-th similarity probability of the to-be-prospected block relative to the j-th comparison block, which may be calculated by the first model.

In an embodiment, the unconventional oil and gas resource includes at least one of following: shale gas, shale oil, coalbed methane, tight sandstone gas, ultra-tight sandstone gas, or tight sandstone oil.

The advantageous effects of the equipment according to the above embodiments are similar to the advantageous effects of the selecting methods provided by the present disclosure, therefore, there is no need to describe again.

The present disclosure further provides devices for selecting key geological parameters of a to-be-prospected block. In an embodiment, as shown in FIG. 3, an electronic device 3 may include a non-transitory memory storage 31 including instructions 32 and one or more processors 30 in communication with the memory storage 31, where the instructions 32, when executed by the one or more processors 30, cause the electronic device to perform steps provided in the method embodiments, such as steps S110 to S140 shown in FIG. 1. The instructions 32, when executed by the one or more processors 30, also may cause the electronic device 3 to realize the functions of the modules provided in the equipment embodiments, such as the modules 210 to 240 shown in FIG. 2.

Exemplarily, the instructions 32 may be divided into one or more modules/units. For example, the instructions 32 may be divided into the modules 210 to 240 shown in FIG. 2. These modules may be stored in the memory storage 31 and executed by one or more processors 30 to implement the selecting methods provided by the present disclosure. These modules may be a series of computer program instruction segments capable of performing specific functions, and the instruction segments can describe the execution process of instructions 32 in electronic device 3.

The electronic device 3 may include, but is not limited to, processor 30 and memory storage 31. Those skilled in the art can understand that FIG. 3 is only an example of electronic device 3, and does not constitute limitation to electronic device 3. The electronic device 3 may include more or less components than shown in FIG. 3, combination of some components, or different components. For example, the electronic device 3 may also include input and output devices, network access devices, buses and the like.

Processor 30 may be Central Processing Units (CPU), other general-purpose processors, Digital Signal Processors (DSP), Application Specific Integrated Circuits (ASIC), Field-Programmable Gate Arrays (FPGA), other programmable logic devices, discrete gates, transistor logic devices, discrete hardware components or the like. The general-purpose processors may be microprocessors, any conventional processors or the like.

Memory storage 31 may be internal storage units of the electronic device 3, such as hard disks or memories of the electronic device 3. Memory storage 31 may also be external storage devices of electronic device 3, such as plug-in hard disks, Smart Memory Cards (SMC), Secure Digital Cards (SD), flash cards and the like equipped on electronic device 3. Further, memory storage 31 may also include both internal storage units and external storage devices of the electronic device 3. Memory storage 31 is used to store instructions 32, other instructions and data required by electronic device 3. Memory storage 31 can also be used to temporarily store data that has been output or will be output.

The present disclosure further provides non-transitory computer readable storage medium storing a computer executable program, where when the computer executable program is executed by a processor, the selecting methods provided by the present disclosure can be performed.

The advantageous effects of both the electronic device and the non-transitory computer readable storage medium are similar to the advantageous effects of the selecting methods provided by the present disclosure, and there is no need to describe again.

Those skilled in the art can clearly understand that, for the convenience and brevity of description, the division of the above-mentioned functional modules is only an example for illustration. In practical applications, the above-mentioned function can be realized by different functional units and modules as required, that is, the internal structure of the electronic device may be divided into different functional units or modules to realize all or part of the functions described above. One or more functional modules in the embodiments may be integrated into one processing unit, each module may exist physically alone, or two or more modules may be integrated into one unit. The above-mentioned integrated units may be implemented in the form of hardware or software functional units. In addition, the specific names of the functional modules are only for the convenience of distinguishing from each other, and do not intend to limit the protection scope of the present disclosure. For the specific operation process of the modules in the above-mentioned electronic device and equipment, reference may be made to the description of corresponding processes in the foregoing embodiments of selecting method, which will not be repeated.

In the above-mentioned embodiments, the description of each embodiment has its own emphasis. For parts that are not described or described in detail in a certain embodiment, reference may be made to the relevant descriptions of other embodiments.

Those skilled in the art can realize that the modules and algorithm steps in the embodiments of the present disclosure can be implemented in electronic hardware, or a combination of computer software and electronic hardware. Whether the functions of these modules and algorithm steps are performed in hardware or software depends on the specific application and design constraints of the technical solution. Those skilled in the art may implement the described functions using different methods for each particular application, which should not be considered beyond the scope of the present disclosure.

In the embodiments provided in the present disclosure, it should be understood that the disclosed electronic devices, equipment and selecting methods may be implemented in other manners. For example, the electronic device in the embodiment described above are merely illustrative. For example, the division of the modules is only a logical function division, and there may be other division manners in actual implementations. For example, multiple units or components may be combined, or may be integrated into another system, or some features may be omitted or not implemented. Besides, the shown or discussed mutual coupling, direct coupling or communication connection may be implemented through some interfaces, indirect coupling or communication connection of devices or units, and may be in electrical, mechanical or other forms.

The units described as separate parts may or may not be physically separate. A component shown as a unit may or may not be a physical unit. It may be located in one place, or it may be distributed over a number of network elements. Some or all of the units may be selected according to actual needs to achieve the purpose of the solution of the embodiments of the present disclosure.

The integrated modules/units, if implemented in the form of software functional units and sold or used as independent products, may be stored in a computer-readable storage medium. Based on this understanding, all or part of the processes in the above embodiments of the selecting methods of the present disclosure can be implemented by instructing relevant hardware through a computer program. The computer program can be stored in a computer-readable storage medium, and when executed by the processor, the computer program can implement the steps in the above-mentioned embodiments of the methods for selecting key geological parameters of a to-be-prospected block. The computer program may include computer program code which may be in the form of source code, object code, executable file, some intermediate form or the like. The computer-readable medium may be: any entity or device capable of carrying the computer program code, recording mediums, U disks, removable hard disks, magnetic disks, optical disks, computer memories, Read-Only Memories (ROM), Random Access Memories (RAM), electric carrier signals, telecommunication signals and software distribution mediums or the like. It should be noted that what the computer-readable media can be may be determined according to the requirements of legislation and patent practice in the jurisdiction, for example, in some jurisdictions, according to legislation and patent practice, the computer-readable media cannot be electrical carrier signals and telecommunication signals.

The above-mentioned embodiments are only used to illustrate the technical solutions of the present disclosure, but not to limit them. Although the present disclosure has been described in detail with reference to the above-mentioned embodiments, those skilled in the art should understand that the technical solutions described in the foregoing embodiments can still be modified, or some technical features thereof can be equivalently replaced. However, these modifications or replacements do not make the essence of the corresponding technical solutions deviate from the spirit and scope of the technical solutions of the embodiments of the present disclosure, and should be included within the protection scope of the present disclosure.

1. A method comprising:
obtaining first sampling values of key geological parameters of m comparison blocks, wherein the m comparison blocks are selected from a plurality of known blocks, each comparison block of the m comparison blocks comprises p key geological parameters, and each key geological parameter of a g-th comparison block of the m comparison blocks has n_{g} first sampling values, and wherein m, p, g and ng are positive integers, and g=1, 2, . . . , m;
obtaining m sets of second sampling values of a to-be-prospected block with an unconventional oil and gas resource, wherein the m sets of second sampling values correspond one-to-one to the m comparison blocks, and each of the m sets of second sampling values comprises p second sampling values that correspond one-to-one to p geological parameters of the to-be-prospected block, and wherein the p geological parameters of the to-be-prospected block correspond one-to-one to and are same as the p key geological parameters of a corresponding comparison block of the m comparison blocks;
inputting first sampling values of the m comparison blocks and second sampling values of the to-be-prospected block to a first model to calculate m similarity probabilities of the to-be-prospected block relative to the m comparison blocks, respectively, the first model being represented as:
$${F}_{g} ( Y ) = ln {q}_{g} + {Y}^{′} {S}^{- 2} {\overline{X}}_{g} - \frac{1}{2} {\overline{{X}^{′}}}_{g} {S}^{- 1} {\overline{X}}_{g} ,$$
wherein:
F_{g}(Y) denotes a g-th similarity probability of the to-be-prospected block relative to the g-th comparison block of the m comparison blocks;
ln q_{g} denotes natural logarithm of q_{g}, q_{g} is a g-th prior probability of the g-th comparison block and q_{g}=n_{g}/N, and N=n₁+n₂+n₃+ . . . +n_{g}+ . . . ++nₘ;
Y′ denotes a matrix of a g-th set of second sampling values of the m sets of second sampling values of the to-be-prospected block, the g-th set of second sampling values corresponds to the g-th comparison block, Y′=[y₁, y₂, y₃, . . . , yₚ], and y₁ to yₚ are p second sampling values of the g-th set of second sampling values;
S⁻¹ is an inverse matrix of S,
$$S = {\sum }_{g = 1}^{m} {S}_{g} / ( N - m ) ,$$
S_{g} is a deviation matrix of the g-th comparison block and S_{g}=[Sₖₜ^{(g)}]_{p×p}, wherein
$${S}_{k t}^{( g )} = {\sum }_{j = 1}^{{n}_{g}} ( {x}_{g j k} - {x}_{g \cdot k} ) ( {x}_{g i k} - {x}_{g \cdot k} ) ,$$
x_{gjk} is a j-th first sampling value of a k-th key geological parameter of the p key geological parameters of the g-th comparison block, x_{gik} is a i-th first sampling value of the k-th key geological parameter of the p key geological parameters of the g-th comparison block, x_{g·k} is a mean of the n_{g} first sampling values of the k-th key geological parameter of the p key geological parameters of the g-th comparison block,
$${X}_{g , k} = \frac{1}{{n}_{g}} {\sum }_{j = 1}^{{n}_{g}} {x}_{g j k} , k = 1 , 2 , … , p ,$$
both i and j are positive integer, and i≠j;
$${\overline{X}}_{g} = [ \begin{matrix}{x}_{g \cdot 1} \\ {x}_{g \cdot 2} \\ ⋮ \\ {x}_{g \cdot p}\end{matrix} ] ,$$
wherein x_{g·l} to x_{g·p} are respective means of the n_{g} first sampling values of the p key geological parameters of the g-th comparison block; and
X̅′̅_{g} is a transposed matrix of X̅_{g};
obtaining m analogy probabilities of the to-be-prospected block relative, respectively, to the m comparison blocks based on the m similarity probabilities of the to-be-prospected block relative to the m comparison blocks, wherein the m analogy probabilities correspond one-to-one with the m similarity probabilities;
selecting a first comparison block from the m comparison blocks as a most relevant block of the to-be-prospected block based on the m analogy probabilities of the to-be-prospected block relative to the m comparison blocks; and
selecting p key geological parameters of the to-be-prospected block from geological parameters of the to-be-prospected block, wherein the p key geological parameters of the to-be-prospected block correspond one-to-one to and are same as the p key geological parameters of the first comparison block.

2. The method of claim 1, wherein the unconventional oil and gas resource comprises at least one of following: shale gas, shale oil, coalbed methane, tight sandstone gas, ultra-tight sandstone gas, or tight sandstone oil.

3. The method of claim 1, wherein the m comparison blocks are selected from the plurality of known blocks by:
categorizing, according to at least one geological condition, the plurality of known blocks to obtain a plurality of categorized known blocks;
determining a category of the to-be-prospected block according to the at least one geological condition; and
selecting, from the plurality of categorized known blocks, the m comparison blocks having a same category as the category of the to-be-prospected block.

4. The method of claim 3, wherein the unconventional oil and gas resource comprises at least one of following: shale gas, shale oil, coalbed methane, tight sandstone gas, ultra-tight sandstone gas, or tight sandstone oil.

5. The method of claim 1, wherein obtaining the m analogy probabilities of the to-be-prospected block relative to the m comparison blocks based on the m similarity probabilities of the to-be-prospected block relative to the m comparison blocks, and selecting the first comparison block from the m comparison blocks as the most relevant block of the to-be-prospected block based on the m analogy probabilities of the to-be-prospected block relative to the m comparison blocks comprises:
inputting, respectively, the m similarity probabilities of the to-be-prospected block relative to the m comparison blocks to a second model to calculate the m analogy probabilities of the to-be-prospected block relative to the m comparison blocks, respectively;
determining a maximum analogy probability of the m analogy probabilities of the to-be-prospected block relative to the m comparison blocks; and
selecting the first comparison block from the m comparison blocks, with the first comparison block corresponding to the maximum analogy probability of the m analogy probabilities.

6. The method of claim 5, wherein the unconventional oil and gas resource comprises at least one of following: shale gas, shale oil, coalbed methane, tight sandstone gas, ultra-tight sandstone gas, or tight sandstone oil.

7. The method of claim 5, wherein the second model is represented as:
$$p \{ g / Y \} = \frac{{q}_{g} \cdot {F}_{g} ( Y )}{{\sum }_{j = 1}^{m} {q}_{j} \cdot {F}_{j} ( Y )} ,$$
wherein:
p{g/Y} denotes a g-th analogy probability of the to-be-prospected block relative to the g-th comparison block of the m comparison blocks;
qⱼ is a j-th prior probability of a j-th comparison block of the m comparison blocks and qⱼ=nⱼ/N, wherein nj is a number of first sampling values of each key geological parameter of the j-th comparison block of the m comparison blocks, nⱼ and j are positive integers, j=1, 2, . .. , m;
F_{g}(Y) is calculated by the first model and denotes the g-th similarity probability of the to-be-prospected block relative to the g-th comparison block; and
Fⱼ(Y) is calculated by the first model and denotes a j-th similarity probability of the to-be-prospected block relative to the j-th comparison block.

8. The method of claim 7, wherein the unconventional oil and gas resource comprises at least one of following: shale gas, shale oil, coalbed methane, tight sandstone gas, ultra-tight sandstone gas, or tight sandstone oil.

9. An electronic device comprising:
a non-transitory memory storage comprising instructions; and
one or more processors in communication with the memory storage, wherein the instructions, when executed by the one or more processors, cause the electronic device to:
obtain first sampling values of key geological parameters of m comparison blocks, wherein the m comparison blocks are selected from a plurality of known blocks, each comparison block of the m comparison blocks comprises p key geological parameters, and each key geological parameter of a g-th comparison block of the m comparison blocks has n_{g} first sampling values, and wherein m, p, g and n_{g} are positive integers, and g=1, 2, . . . , m;
obtain m sets of second sampling values of a to-be-prospected block with an unconventional oil and gas resource, wherein the m sets of second sampling values correspond one-to-one to the m comparison blocks, and each of the m sets of second sampling values comprises p second sampling values that correspond one-to-one to p geological parameters of the to-be-prospected block, and wherein the p geological parameters of the to-be-prospected block correspond one-to-one to and are same as the p key geological parameters of a corresponding comparison block of the m comparison blocks;
input first sampling values of the m comparison blocks and second sampling values of the to-be-prospected block to a first model to calculate m similarity probabilities of the to-be-prospected block relative to the m comparison blocks, respectively, the first model being represented as:
$${F}_{g} ( Y ) = ln {q}_{g} + {Y}^{′} {S}^{- 1} {\overline{X}}_{g} - \frac{1}{2} \overline{{X}_{g}^{′}} {S}^{- 1} \overline{{X}_{g} ,}$$
wherein:
F_{g}(Y) denotes a g-th similarity probability of the to-be-prospected block relative to the g-th comparison block of the m comparison blocks;
ln q_{g} denotes natural logarithm of q_{g}, q_{q} is a g-th prior probability of the g-th comparison block and q_{g}=n_{g}/N, and N=n₁+n₂+n₃+ . . . +n_{g}+ . . . ++nₘ;
Y′ denotes a matrix of a g-th set of second sampling values of the m sets of second sampling values of the to-be-prospected block, the g-th set of second sampling values corresponds to the g-th comparison block, Y′=[y₁, y₂, y₃, . . . , yₚ], and y₁ to yₚ are p second sampling values of the g-th set of second sampling values;
S⁻¹ is an inverse matrix of S,
$$S = {\sum }_{g = 1}^{m} {S}_{g} / ( N - m ) ,$$
S_{g} is a deviation matrix of the g-th comparison block and S_{g}=[Sₖₜ^{(g)}]_{p×p}, wherein
$${S}_{k t}^{( g )} = {\sum }_{j = 1}^{{n}_{g}} ( {x}_{g j k} - {x}_{g \cdot k} ) ( {x}_{g i k} - {x}_{g \cdot k} ) ,$$
x_{gjk} is a j-th first sampling value of a k-th key geological parameter of the p key geological parameters of the g-th comparison block, x_{gik} is a i-th first sampling value of the k-th key geological parameter of the p key geological parameters of the g-th comparison block, x_{g·k} is a mean of the n_{g} first sampling values of the k-th key geological parameter of the p key geological parameters of the g-th comparison block,
$${X}_{g , k} = \frac{1}{{n}_{g}} {\sum }_{j = 1}^{{n}_{g}} {x}_{g j k} , k = 1 , 2 , … , p ,$$
both i and j are positive integer, and i≠j;
$${\overline{X}}_{g} = [ \begin{matrix}{x}_{g \cdot 1} \\ {x}_{g \cdot 2} \\ ⋮ \\ {x}_{g \cdot p}\end{matrix} ] ,$$
wherein x_{g·l} to x_{g·p} are respective means of the n_{g} first sampling values of the p key geological parameters of the g-th comparison block; and
X̅′̅_{g} is a transposed matrix of X̅_{g};
obtain m analogy probabilities of the to-be-prospected block relative, respectively, to the m comparison blocks based on the m similarity probabilities of the to-be-prospected block relative to the m comparison blocks, wherein the m analogy probabilities correspond one-to-one with the m similarity probabilities;
select a first comparison block from the m comparison blocks as a most relevant block of the to-be-prospected block based on the m analogy probabilities of the to-be-prospected block relative to the m comparison blocks; and
select p key geological parameters of the to-be-prospected block from geological parameters of the to-be-prospected block, wherein the p key geological parameters of the to-be-prospected block correspond one-to-one to and are same as the p key geological parameters of the first comparison block.

10. A non-transitory computer readable storage medium storing a computer executable program, wherein when the computer executable program is executed by a processor, a method is performed, and the method comprises:
obtaining first sampling values of key geological parameters of m comparison blocks, wherein the m comparison blocks are selected from a plurality of known blocks, each comparison block of the m comparison blocks comprises p key geological parameters, and each key geological parameter of a g-th comparison block of the m comparison blocks has n_{g} first sampling values, and wherein m, p, g and ng are positive integers, and g=1, 2, . . . , m;
obtaining m sets of second sampling values of a to-be-prospected block with an unconventional oil and gas resource, wherein the m sets of second sampling values correspond one-to-one to the m comparison blocks, and each of the m sets of second sampling values comprises p second sampling values that correspond one-to-one to p geological parameters of the to-be-prospected block, and wherein the p geological parameters of the to-be-prospected block correspond one-to-one to and are same as the p key geological parameters of a corresponding comparison block of the m comparison blocks;
inputting first sampling values of the m comparison blocks and second sampling values of the to-be-prospected block to a first model to calculate m similarity probabilities of the to-be-prospected block relative to the m comparison blocks, respectively, the first model being represented as:
$${F}_{g} ( Y ) = ln {q}_{g} + {Y}^{′} {S}^{- 1} {\overline{X}}_{g} - \frac{1}{2} \overline{{X}_{g}^{′}} {S}^{- 1} \overline{{X}_{g} ,}$$
wherein:
F_{g}(Y) denotes a g-th similarity probability of the to-be-prospected block relative to the g-th comparison block of the m comparison blocks;
ln q_{g} denotes natural logarithm of q_{g}, q_{g} is a g-th prior probability of the g-th comparison block and qg_{g}=n_{g}/N, and N=n₁+n₂+n₃+ . . . +n_{g}+ . . . ++nₘ;
Y′ denotes a matrix of a g-th set of second sampling values of the m sets of second sampling values of the to-be-prospected block, the g-th set of second sampling values corresponds to the g-th comparison block, Y′=[y₁, y₂, y₃, . . . , yₚ], and y₁ to yₚ are p second sampling values of the g-th set of second sampling values;
S⁻¹ is an inverse matrix of S,
$$S = {\sum }_{g = 1}^{m} {S}_{g} / ( N - m ) ,$$
S_{g} is a deviation matrix of the g-th comparison block and S_{g}=[Sₖₜ^{(g)}]_{p×p}, wherein
$${S}_{k t}^{( g )} = {\sum }_{j = 1}^{{n}_{g}} ( {x}_{g j k} - {x}_{g \cdot k} ) ( {x}_{g i k} - {x}_{g \cdot k} ) ,$$
x_{gjk} is a j-th first sampling value of a k-th key geological parameter of the p key geological parameters of the g-th comparison block, x_{gik} is a i-th first sampling value of the k-th key geological parameter of the p key geological parameters of the g-th comparison block, x_{g·k} is a mean of the n_{g} first sampling values of the k-th key geological parameter of the p key geological parameters of the g-th comparison block,
$${X}_{g , k} = \frac{1}{{n}_{g}} {\sum }_{j = 1}^{{n}_{g}} {x}_{g j k} , k = 1 , 2 , … , p ,$$
both i and j are positive integer, and i≠j;
$${\overline{X}}_{g} = [ \begin{matrix}{x}_{g \cdot 1} \\ {x}_{g \cdot 2} \\ ⋮ \\ {x}_{g \cdot p}\end{matrix} ] ,$$
wherein x_{g·l} to x_{g·p} are respective means of the n_{g} first sampling values of the p key geological parameters of the g-th comparison block; and
XX̅′̅_{g} is a transposed matrix of X̅_{g};
obtaining m analogy probabilities of the to-be-prospected block relative, respectively, to the m comparison blocks based on the m similarity probabilities of the to-be-prospected block relative to the m comparison blocks, wherein the m analogy probabilities correspond one-to-one with the m similarity probabilities;
selecting a first comparison block from the m comparison blocks as a most relevant block of the to-be-prospected block based on the m analogy probabilities of the to-be-prospected block relative to the m comparison blocks; and
selecting p key geological parameters of the to-be-prospected block from geological parameters of the to-be-prospected block, wherein the p key geological parameters of the to-be-prospected block correspond one-to-one to and are same as the p key geological parameters of the first comparison block.
